(19) United States
(12) Patent Application Publication
(10) Pub. No.: US 2002/0071985 A1
(43) Pub. Date: Jun. 13, 2002

(54) Sealed battery

(75) Inventor: Norihide Ooyama, Utsunomiya-Shi (JP)

Correspondence Address: ARMSTRONG,WESTERMAN & HATTORI, LLP, 1725 K STREET, NW., SUITE 1000, WASHINGTON, DC, 20006, US

(73) Assignee: NEC MOBILE ENERGY CORPORATION, Utsunomiya-shi (JP)

(21) Appl. No.: 10/004,803

(22) Filed: Dec. 7, 2001

(30) Foreign Application Priority Data
Dec. 8, 2000 (JP) 2000-374373

(51) Int. Cl. H01M 2/08

(52) U.S. Cl. 429/94; 429/174; 429/181

(57) ABSTRACT

The present invention provides a sealed battery, which comprises a battery element sealed by a flexible external material, said battery element being produced by winding up a positive electrode and a negative electrode each in band-like shape with a separator therebetween, said battery element comprises a wound-up element having plane portions and curved portions, and an active material layer is formed at least on one of the surfaces of the curved portions positioned on outermost periphery of each of the positive electrode and the negative electrode.

### BACKGROUND OF THE INVENTION

The present invention relates to a sealed battery, and in particular, to a sealed battery in rectangular shape sealed by a flexible external material.

A battery used as a power source for a small size electronic device including the so-called mobile device such as portable handyphone, lithium ion battery or lithium polymer battery in rectangular or similar shape is generally used to match the shape of battery container.

An example is taken now on a rectangular type lithium ion battery. A positive electrode comprising a positive electrode active material layer containing a lithium transition metal composite oxide and a negative electrode comprising a negative electrode active material layer containing carbonaceous material where lithium can be doped or undoped are wound up via a separator between them to make up a battery element, and this battery element is placed in a sealed container and is sealed. In a type of battery using a battery case as the sealed container, a metal material such as nickel-plated soft steel or aluminum alloy is used as the container. In this respect, there is a limitation in producing the battery in small size and lightweight design. Thus, a type of battery is proposed, which uses a flexible external material such as a laminated film produced by laminating a thermal fusion type synthetic resin film and a metal film such as aluminum.

FIG. 4 represents drawings to explain a sealed battery, which is sealed using a conventional type flexible external material. FIG. 4(A) is a perspective view, and FIG. 4(B) is a cross-sectional view along the line A-A′ in FIG. 4(B).

In a sealed battery 1 containing a battery element, the battery element is sealed by a flexible external material 2. The battery element 4 is produced by winding up a negative electrode and a positive electrode each in band-like shape and two separators, and it is fixed by a fixing tape 3. A positive electrode conductive tab 8 and a negative electrode conductive tab 9 are bonded to the battery element.

One of the conductive tabs, e.g. the positive electrode conductive tab 8 in FIG. 3, is positioned at A the center of the battery element 4, and the negative electrode conductive tab 9 is positioned on a periphery of the battery element 4.

The positive electrode conductive tab 8 positioned at the center and the negative electrode conductive tab 9 at the periphery are separated from each other by a certain distance in the laminating direction of the electrodes, i.e. in radial direction of the wound-up element. One of the conductive tabs, e.g. the positive electrode conductive tab 8 in FIG. 4(A), is bent, and it is covered with an insulating material 15.

The positive electrode 5 and the negative electrode 6 are wound with the separator 7 between them. On the surface of a current collector on the outermost periphery of the positive electrode 5 and the negative electrode 6, a non-coated portion 16 not coated with active material layer is provided. After winding up, this is fixed by a fixing tape 3 and is sealed by the flexible external material 2. To facilitate assembling procedure of these components and to fix them and to prevent them from being separated, a long non-coated portion 16 where the active material layer is not coated is provided on the outermost periphery.

However, in this type of sealed battery, the property may be impaired due to shock when the battery is accidentally dropped down, and short-circuiting often occurs in the battery when the sealed battery or the device using the battery is accidentally dropped down. This problem is more likely to occur in case of a thin type battery. It is particularly remarkable in case of a battery of 4 mm or less in thickness.

It is an object of the present invention to provide a sealed battery, which comprises a battery element produced by winding up a positive electrode and a negative electrode with a separator between them, and the battery element is sealed by a flexible external material, and satisfactory sealing property is ensured to prevent the battery from internal short-circuiting when the sealed battery or a device using the battery is accidentally dropped down.

### SUMMARY OF THE INVENTION

The present invention provides a sealed battery, which comprises a battery element sealed by a flexible external material, said battery element being produced by winding up a positive electrode and a negative electrode each in band-like shape with a separator therebetween, said battery element comprises a wound-up element having plane portions and curved portions, and an active material layer is formed at least on one of the surfaces of the curved portions positioned on outermost periphery of each of the positive electrode and the negative electrode.

Also, the present invention provides a sealed battery as described above, wherein a positive electrode conductive tab and a negative electrode conductive tab are positioned on the positive electrode and the negative electrode respectively on the outermost periphery of the battery element and the element is sealed.

Further, the present invention provides a sealed battery as described above, wherein a layer coated with a thermal fusion material or a thermal fusion film is attached on a portion where the positive electrode conductive tab and the negative electrode conductive tab are sealed with the external material.

Also, the present invention provides a sealed battery as described above, wherein the battery element is accommodated in a recessed portion of the flexible external material having plane portions and recessed portions, and the positive electrode conductive tab and the negative electrode conductive tab of the battery element are positioned on the plane portion and the element is sealed.

Further, the present invention provides a sealed battery as described above, wherein said battery is a lithium ion battery or a lithium polymer battery.

### BRIEF DESCRIPTION OF THE DRAWINGS

FIG. 1 represents drawings to explain an embodiment of a sealed battery according to the present invention. FIG. 1(A) is a perspective view, and FIG. 1(B) is a cross-sectional view along the line A-A′ in FIG. 1(A);

FIG. 2 represents drawings to explain another embodiment of the sealed battery of the present invention. FIG. 2(A) is a perspective view, and FIG. 2(B) is a cross-sectional view along the line A-A′ in FIG. 2(A);

FIG. 3 is a drawing to explain an embodiment of a sealed battery having a positive electrode positioned on the outermost periphery, and it is a cross-sectional view of a battery element; and

FIG. 4 represents drawings to explain a sealed battery sealed by a flexible external material as used in the past.

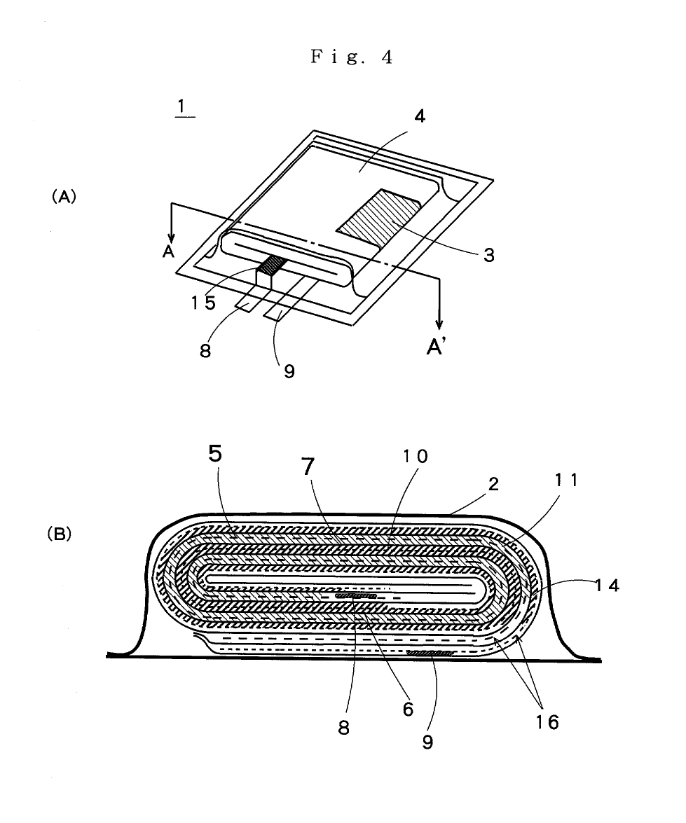

### DESCRIPTION OF THE PREFERRED EMBODIMENT

The present invention provides a sealed battery, in which a battery element is sealed by a flexible external material. Internal short-circuiting may occur due to shock when the battery is accidentally dropped down. In this case, a separator between a positive electrode and a negative electrode is damaged, and, as a result, short-circuiting occurs between the positive and the negative electrodes. In particular, damage of the separator is very likely to occur on a curved portion of the battery element, which is in form of a bobbin and comprises plane portions and curved portions, or on a rectangular portion where an active material layer is not provided on current collector of the positive electrode, and this results in internal short-circuiting.

The damage of the separator which causes the short-circuiting can be eliminated by the use of a positive electrode, which has the active material layer except the plane portion on the current collector on outer periphery of the positive electrode.

In a battery such as a lithium ion battery where a metal such as lithium is doped or undoped, when electric current is concentrated on the surface of the negative electrode during electric charging, undoped metal may be deposited on the negative electrode. When the metal being deposited on the surface of the negative electrode grows in form of a dendrite crystal, it may penetrate the separator and may cause short-circuiting with the positive electrode. In this respect, the negative electrode is designed to be longer than the positive electrode, and the negative electrode is positioned beyond the end of the positive electrode so that concentration of electric current at the end of the negative electrode can be avoided.

In this type of sealed battery, aluminum is generally used as the current collector of the positive electrode. Corner portion or curved portion where positive electrode active material layer is not provided on the surface has higher hardness. When the battery is dropped down, this portion acts as a projection, and this may lead to the damage of the separator.

However, when positive electrode active material layer is provided on the surface of the positive electrode current collector which is made of a material such as aluminum, the current collector is bent at obtuse angle or acts as a curved surface because of the positive electrode active material layer, and the positive electrode active material layer may play a role of a buffer material. Thus, when the battery is dropped down, the shock applied on the separator may be reduced or eliminated.

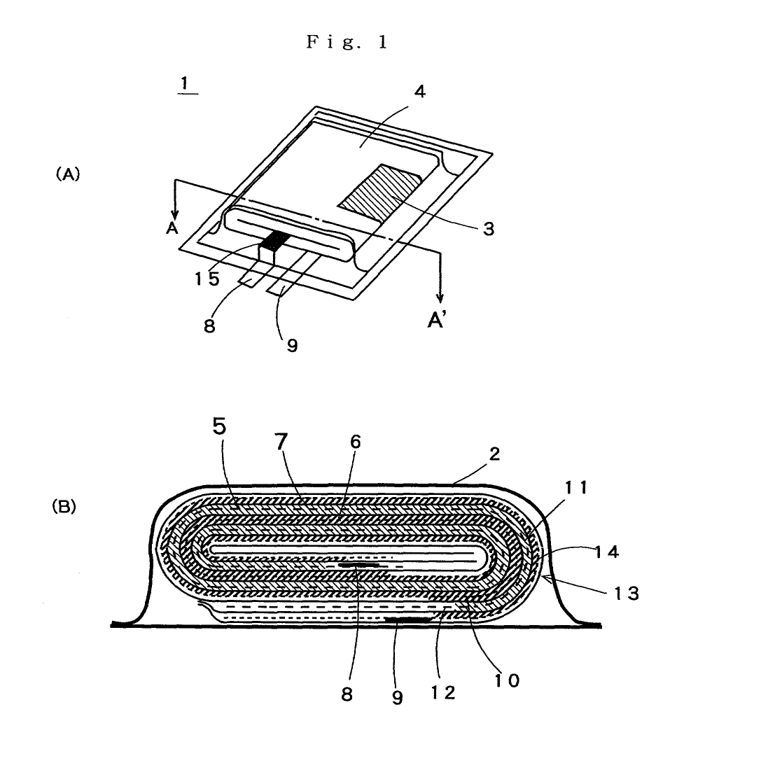

FIG. 1 represents drawings to explain an embodiment of a battery according to the present invention. FIG. 1 (A) is a perspective view, and FIG. 1(B) is a cross-sectional view along the line A-A′ in FIG. 1(A).

In a sealed battery 1 of the present invention, a battery element 4 fixed by a fixing tape 3 is sealed by a flexible external material 2. The battery element 4 comprises a positive electrode 5, a separator 6, and a negative electrode 7. The battery element is designed, not in cylindrical shape, but in form of a bobbin or a spool, which comprises plane portions and curved portions. In the present invention, the plane portion is not a plane in strict sense of the word. Its cross-section contains not only linear portion but a portion gently curved. Thus, it represents a battery element to be used in rectangular type battery.

On the innermost periphery of the positive electrode 5 of the battery element, a positive electrode conductive tab 8 is provided. On the outermost periphery of the It negative electrode 6, a negative electrode conductive tab 9 is provided.

Therefore, the positive electrode conductive tab 8 is bent and is covered with an insulating material 15. Then, it is arranged on the same plane as the negative electrode conductive tab 9, and these are sealed by the flexible external material.

A negative electrode active material layer 10 of the negative electrode is arranged in a wider area than a positive electrode active material layer 11 which is at face-to-face position to the active material layer 10. A portion 12 not coated with the positive electrode active material on the outermost periphery of the battery element is not present on a curved portion 13 of the battery element wound up in form of a bobbin. On the curved portion, the positive electrode active material layer 11 is arranged.

The negative electrode active material layer 10 of the negative electrode 6 is always present on a region, which is facing to the region of the positive electrode active material. The outermost periphery of the negative electrode can be arranged only on the surface facing to the positive electrode. Accordingly, the outermost periphery of the negative electrode may be a portion 14, which is coated with the active material layer only on one surface.

In the battery as described above, the positive electrode conductive tab 8 is positioned at the center of the battery element 4. Therefore, winding distortion may occur due to the positive electrode conductive tab on the battery element. In particular, in a thin type battery, the positive electrode conductive tab may occupy a larger portion on the battery element. This means that the influence of the winding distortion caused by the positive electrode conductive tab 8 at the center is higher in the thin type battery. On the portion where winding distortion occurred, electric current distribution becomes uneven. Thus, heating may occur on the portion where electric current is concentrated, or partial deterioration of the battery may proceed more quickly. Therefore, it is preferable that the battery does not have the conductive tab at the center of the battery element.

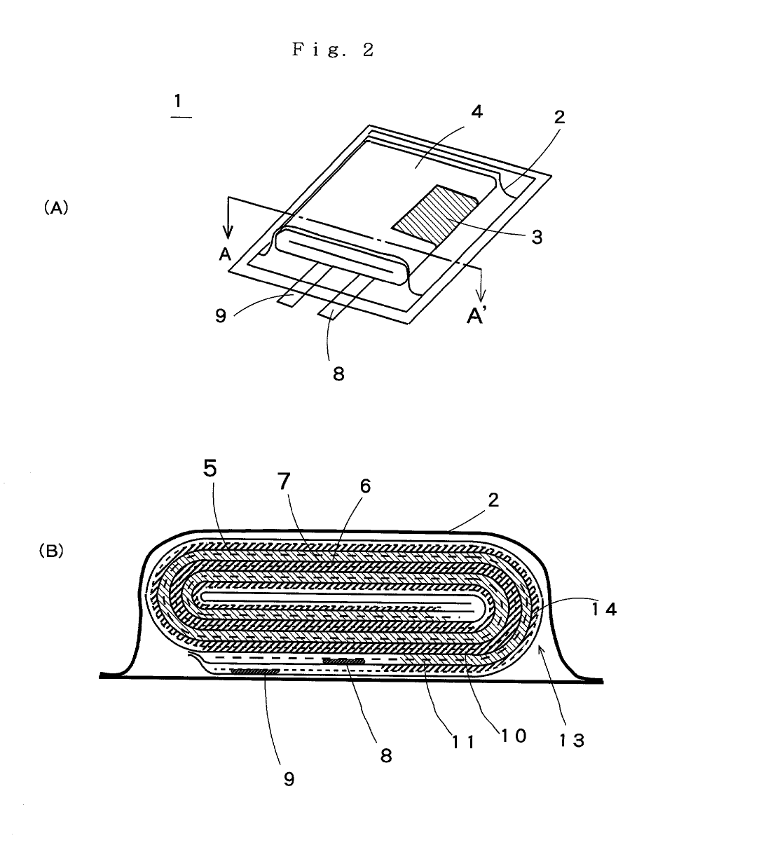

FIG. 2 represents drawings to explain another embodiment of the battery of the present invention. FIG. 2(A) is a perspective view, and FIG. 2(B) is a cross-sectional view along the line A-A′ in FIG. 2(A).

In a sealed battery 1 of the present invention, a battery element 4 fixed by a fixing tape 3 is sealed by a flexible external material 2. In the battery element 4, a positive electrode 5 and a negative electrode 6 are arranged with a separator 7 between them.

On the outermost periphery of each of the positive electrode 5 and the negative electrode 6 of the battery element, a positive electrode conductive tab 8 and a negative electrode conductive tab 9 are provided.

The positive electrode conductive tab 8 and the negative electrode conductive tab 9 are arranged substantially on the same plane.

Therefore, there is no need to bend the positive electrode conductive tab 8 and the negative electrode conductive tab 9, and these can be sealed on the same plane by the external material.

A negative electrode active material layer 10 is provided in a wider area than a positive electrode active material layer 11. A portion 12 not coated with the positive electrode active material on the outermost periphery of the battery element is not present on a curved portion 13 of the battery element wound up in form of a bobbin, and the curved portion is covered with the positive electrode active material layer 11.

A negative electrode active material layer 10 of the negative electrode 6 is always present in a region, which is at face-to-face position to a region where the positive electrode active material is present. However, it would suffice that the outermost periphery of the negative electrode is formed only on the surface which faces to the positive electrode. Accordingly, the outermost periphery of the negative electrode may be a portion 14 coated with the active material layer only on one surface.

In the above, description has been given on a sealed battery, which has the negative electrode on outer side. Next, description will be given on a sealed battery, which has the positive electrode arranged on outer side.

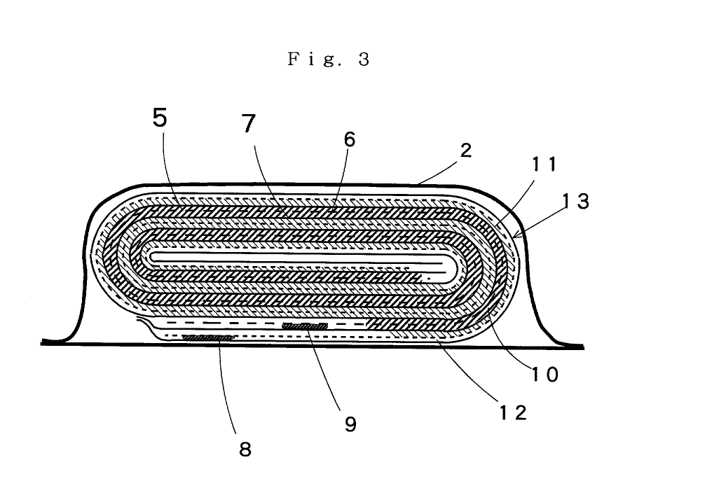

FIG. 3 is a drawing to explain an embodiment of the A sealed battery, which has the positive electrode on the outermost periphery. It is a cross-sectional view of the battery element.

A positive electrode 5 and a negative electrode 6 are arranged with a separator 7 between them. The positive electrode 5 is arranged on outer side, and the positive electrode is positioned on the outermost periphery of the battery element. On the outer surface of the positive electrode on the outermost periphery, a positive electrode active material layer 11 is not provided and it is a portion 12 not coated with the positive electrode active material. The positive electrode active material layer 11 is formed only on the inner surface.

A curved portion 13 on inner side of the positive electrode of the outermost periphery is covered with the positive electrode active material layer.

On the other hand, on the negative electrode, the region of the negative electrode active material layer is designed to be wider than the positive electrode active material layer which matches the negative electrode active material layer so that metal lithium may not be deposited on the surface of the negative electrode during electric charging. Therefore, the negative electrode active material layer is formed on a wider area than the surface where the positive electrode active material layer is formed on inner side of the curved portion of the outermost periphery of the positive electrode. By designing in such a structure, it is possible to reduce the shock applied on the separator when the battery is accidentally dropped down.

The sealed battery of the present invention can be applied in various types of sealed battery such as lithium ion battery, polymer lithium battery, etc.

Description will be given below by taking an example on a lithium ion battery. A positive electrode coating material is prepared by dispersing and kneading composite oxide (for instance, LiₓCoO₂, LiₓNiO₂, LiₓMn₂O₄, LiₓMnO₃, LiₓNi_{y}Co_{(1-y)}O₂, etc.) , a conductive material such as carbon black, and a binder such as polyvinylidene fluoride (PVDF), etc. in a solvent such as N-methyl-2-pyrolidone (NMP). This coating material is coated by a coating device of the present invention on a band-like aluminum foil. When coating is completed on one surface, the other surface is coated after the first coated surface is dried, and the coating material is coated on both surfaces.

For the negative electrode, a negative electrode coating solution is prepared by using thermally decomposable carbons, on which lithium can be doped or undoped, cokes such as pitch cokes, needle cokes, petroleum cokes, etc., graphite, vitrified carbons, organic macromolecular compound fired products produced by firing phenol resin, furane resin, etc., carbonaceous material such as carbon fiber, activated carbon, etc., conductive macromolecular materials such as polyacetylene, or polypyrrole. These substances were dispersed and kneaded with a conductive material such as carbon black and a binder such as polyvinylidene fluoride (PVDF) in a solvent such as N-methyl-2-pyrolidone (NMP). This negative electrode coating solution is coated using a coating device of the present invention on the surface of a band-like copper foil. When coating is completed on one surface, the other surface is coated after drying the first coated surface, and both surfaces are coated.

In the negative electrode, the portion with its one side not facing to the positive electrode active material layer when the battery element is prepared by winding up, the negative electrode active material layer may be formed on one surface only.

Next, the negative electrode conductive tab and the positive electrode conductive tab are bonded to the negative electrode and the positive electrode by means such as ultrasonic welding, resistance welding, etc. Then, this is wound up using a winding device. The battery element is fixed by a fixing tape, and by pressing this, it is molded into a predetermined shape, comprising plane portions and curved portions.

As the flexible external material to be used in the sealed battery of the present invention, thermoplastic resin layer such as polyethylene, polypropylene, ionomer, ethylene-methacrylate copolymer resin, or ethylene-(meth)acrylate copolymer resin is bonded to the surface of an aluminum foil facing to inner side of the battery via an adhesive layer or without the adhesive layer by thermal fusion. On the opposite side, polyester resin such as polyethylene terephthalate or nylon resin is laminated and used.

When moisture enters from bonded surface of polyethylene, polypropylene, etc. on inner side into the battery container, LiPF₆ used as electrolyte is decomposed and hydrofluoric acid may be generated, and this may adversely affect the active material of the battery or may induce corrosion of aluminum in the external material. In this respect, it is very important to maintain the performance characteristics of the sealed surface for long time.

To improve thermal fusion property of the sealed surface, a non-stretched polyethylene film having good fusion property may be used. Or, a maleic acid denatured olefin resin layer may be formed on the sealed surface.

Further, on the portion where the positive electrode conductive tab and the negative electrode conductive tab come into contact with the external material, maleic acid olefin may be coated in advance for surface treatment. Or, the surface may be coated with maleic acid olefin film to have higher bonding strength with the external material.

In the following, description will be given on examples to explain the present invention:

### EXAMPLE 1

On the surface of an aluminum foil in size of 205×20×0.02 mm (length×width×thickness), a positive electrode active material comprising lithium manganate, carbon black, polyvinylidene fluoride, and N-methyl-pyrolidone was coated except a portion 19 mm from the longitudinal end of the aluminum foil, and a positive electrode conductive tab was bonded to non-coated portion where the positive electrode active material was not coated.

On the other hand, on the surface of a copper foil in size of 212×21.4×0.01 mm (length×width×thickness), a negative electrode active material comprising graphite, carbon black, polyvinylidene fluoride, and N-methyl-pyrolidone was coated except a portion 18 mm from the longitudinal end of the aluminum foil. A negative electrode conductive tab was bonded to a portion where the negative electrode active material was not coated.

A separator made of polyethylene of 25 μm in thickness was arranged between the positive electrode and the negative electrode and outside the negative electrode, and these were wound up to have the negative electrode positioned on outer side. Then, press molding was performed so that two surfaces were to run in parallel to each other. Curved portions on the outermost periphery of the positive electrode and the negative electrode of the battery element were covered with the active material layer.

A battery thus prepared was placed in a rectangular container similar to a portable device of 70 g in weight. This was dropped down from height of 75 cm and 1 m respectively by 15 times each. This test was carried out for 200 batteries. When battery voltage was determined, internal short-circuiting was found in none of these batteries.

### COMPARATIVE EXAMPLE 1

The non-coated portion not coated with the positive electrode active material of the positive electrode and the negative electrode was provided on a portion 23 mm from the longitudinal end. A non-coated portion not coated with the negative electrode active material was provided on a portion 22 mm from the longitudinal end. Then, these were wound up to prepare a sealed battery by the same procedure as in Example 1 except that a portion not coated with the positive electrode active material layer was present. Evaluation was performed by the same procedure as in Example 1. Internal short-circuiting was found in 0.5% of the batteries when the batteries were dropped down from a height of 75 cm, and in 2.5% of the batteries when the batteries were dropped from a height of 1 m.

The sealed battery of the present invention has an active material layer on curved portion of the electrode on the outermost periphery of the battery element. When the battery is accidentally dropped down, no damage occurs on the separator due to shock. Thus, it is possible to produce the sealed battery,with high reliability.

What is claimed is:

1. A sealed battery, comprising a battery element sealed by a flexible external material, said battery element being produced by winding up a positive electrode and a negative electrode each in band-like shape with a separator therebetween, said battery element comprises a wound-up element having plane portions and curved portions, and an active material layer is formed at least on one of the surfaces of the curved portions positioned on outermost periphery of each of the positive electrode and the negative electrode.

2. A sealed battery according to claim 1, wherein a positive electrode conductive tab and a negative electrode conductive tab are positioned on the positive electrode and the negative electrode respectively on the outermost periphery of the battery element and the element is sealed.

3. A sealed battery according to claim 2, wherein a layer coated with a thermal fusion material or a thermal fusion film is attached on a portion where the positive electrode conductive tab and the negative electrode conductive tab are sealed with the external material.

4. A sealed battery according to claim 2, wherein the battery element is accommodated in a recessed portion of the flexible external material having plane portions and recessed portions, and the positive electrode conductive tab and the negative electrode conductive tab of the battery element are positioned on the plane portion and the element is sealed.

5. A sealed battery according to claim 3, wherein the battery element is accommodated in a recessed portion of the flexible external material having plane portions and recessed portions, and the positive electrode conductive tab and the negative electrode conductive tab of the battery element are positioned on the plane portion and the element is sealed.

6. A sealed battery according to claim 1, wherein said battery is a lithium ion battery or a lithium polymer battery.
